(19) United States
(12) Patent Application Publication
(10) Pub. No.: US 2009/0283423 A1
(43) Pub. Date: Nov. 19, 2009

(54) WATER ANALYSIS USING A PHOTOELECTROCHEMICAL METHOD

(75) Inventors: Huijun Zhao, Highland Park (AU); Shanqing Zhang, Mudgeeraba (AU)

Correspondence Address: CONNOLLY BOVE LODGE & HUTZ LLP, 1875 EYE STREET, N.W., SUITE 1100, WASHINGTON, DC, 20006, US

(73) Assignee: Aqua Diagnostic Pty Ltd, South Melbourne, Victoria (AU)

(21) Appl. No.: 12/063,308

(22) PCT Filed: Aug. 10, 2006
(86) PCT No.: PCT/AU06/01132

§ 371 Date: Feb. 11, 2008

(30) Foreign Application Priority Data
Aug. 11, 2005 (AU) 2005904307

(51) Int. Cl. G01N 27/26

(52) U.S. Cl. 205/788; 204/406

(57) ABSTRACT

A method of determining chemical oxygen demand in water samples containing chloride ions above 0.5 mM concentration in which the samples are diluted and a known quantity of an organic substance is added to the diluted sample which is the subjected to an assay by a photoelectrochemical method using a titanium dioxide nanoparticulate semiconductor electrode and measuring the photo current produced until a stable value is reached and then using the difference between the initial and stable photocurrents as a measure of the chemical oxygen demand. An alternative method involves determining chemical oxygen demand in water samples containing chloride ions by measuring the chlorine content and measuring chemical oxygen demand by a photoelectrochemical method using a titanium dioxide nanoparticulate semiconductor electrode and adjusting the chemical oxygen demand measurement using the chlorine measurement.

### FIELD OF THE INVENTION

This invention relates to a new method for determining oxygen demand of water using photoelectrochemical cells. In particular, the invention relates to a direct photoelectrochemical method of determining chemical oxygen demand of water samples using a titanium dioxide nanoparticulate semiconductive electrode.

### BACKGROUND TO THE INVENTION

Nearly all domestic and industrial wastewater effluents contain organic compounds, which can cause detrimental oxygen depletion (or demand) in waterways into which the effluents are released. This demand is due largely to the oxidative biodegradation of organic compounds by naturally occurring microorganisms, which utilize the organic material as a food source. In this process, organic carbon is oxidised to carbon dioxide, while oxygen is consumed and reduced to water.

Standard analytical methodologies for the determination of aggregate properties such as oxygen demand in water are biochemical oxygen demand (BOD) and chemical oxygen demand (COD). BOD involves the use of heterotrophic microorganisms to oxidise organic material and thus estimate oxygen demand, COD uses strong chemical oxidising agents, such as dichromate or permanganate, to oxidise organic material. BOD analysis is carried out over five days and oxygen demand determined by titration or with an oxygen probe. COD measures dichromate or permanganate depletion by titration or spectrophotometry.

Despite their widespread use for estimating oxygen demand, both BOD and COD methodologies have serious technological limitations. Both methods are time consuming and very expensive, costing water industries and local authorities in excess of $1 billion annually worldwide. Other problems with the BOD assay include: limited linear working range; complicated, time consuming procedures; and questionable accuracy and reproducibility (the standard method accepts a relative standard deviation of ±15% for replicate BOD₅ analyses). More importantly, interpretation of BOD results is difficult since the results tend to be specific to the body of water in question, depend on the pollutants in the sample solution and the nature of the microbial seed used. In addition, the BOD methodologies cannot be used to assess the oxygen demand for many heavily polluted water bodies because of inhibitory and toxic effects of pollutants on the heterotropic bacteria.

The COD method is more rapid and less variable than the BOD method and thus preferred for assessing the oxygen demand of organic pollutants in heavily polluted water bodies. Despite this, the method has several drawbacks in that it is time consuming, requiring 2-4 hours to reflux samples, and utilises expensive (e.g. Ag₂SO₄), corrosive (e.g. concentrated H₂SO₄) and highly toxic (Hg(II) and Cr(VI)) reagents. The use of toxic reagents being of particular environmental concern, leading to the Cr(VI) method being abandoned in Japan.

Application WO2004/088305 discloses a photoelectrochemical method of detecting chemical oxygen demand as a measure of water quality using a titanium dioxide nanoparticulate semiconductor electrode. Titanium(IV) oxide (TiO₂) has been extensively used in photooxidation of organic compounds. TiO₂ is non-photocorrosive, non-toxic, inexpensive, relatively easily synthesised in its highly active catalytic nanoparticulate form, and is highly efficient in photooxidative degradation of organic compounds.

A problem encountered in conducting assays using this method is dealing with interference from competing oxidisable chemical species other than organic carbon. Filtration of samples reduces interference from many species but the presence of chloride still remains a significant interference that must be dealt with. The standard COD detection method deals with chloride interference by chemically removing the chloride ions. The principle is to add a chemical that can form insoluble compounds with Cl⁻, which can then be separated from the sample solution (see following reactions):

2Hg⁺(aq)+2Cl⁻(aq)→Hg₂Cl₂↓(solid), Kₛₚ=1.3×10⁻¹⁸

Ag⁺(aq)+Cl⁻(aq)→AgCl↓(solid), Kₛₚ=1.0×10⁻¹⁰

The method involves the use of expensive and toxic chemicals and requiring separation. For online applications, the system will need a sophisticated component to achieve in situ separation of precipitated AgCl or Hg₂Cl₂, which, on one hand will significantly undermine the accuracy and reliability of the system, and on the other hand will increase both the capital and operational costs.

The method may be suitable for lab analysis, but unsuitable for on-line rapid analysis.

It is an object of this invention to provide a simpler method of dealing with chloride interference.

### BRIEF DESCRIPTION OF THE INVENTION

In a first embodiment the present invention provides a method of determining chemical oxygen demand in water samples containing chloride ions which includes the step of measuring the chlorine content and measuring chemical oxygen demand by a photoelectrochemical method using a titanium dioxide nanoparticulate semiconductor electrode and adjusting the chemical oxygen demand measurement using the chlorine measurement.

All methods described previously are based on the physical removal of interfering species. Apart from precipitation, removal is also possible using electrochemical deposition at a silver or mercury electrode. The problem with that removal technique is that the electrodes need to be regularly regenerated or replaced.

The mathematical method proposed in this first embodiment of the invention is an in situ method that does not require the physical removal Cl⁻ from sample solution. The method involves the analytical estimation of Cl⁻ concentration, which can be achieved by either direct measuring Cl⁻ by a sensor probe or by an indirect conductivity measurement with a conductivity probe. Once the chloride concentration is known, its effect on the COD measurement can be mathematically deducted from the COD measured because Cl⁻ is quantitatively oxidised to CO₂ during photocatalysis process (see equation below).

2Cl⁻+hv→Cl₂+2e⁻

Since COD is calculated according to the following reaction:

O₂+4H⁺+4e⁻→H₂O

This means one O₂ is equivalent to 4 electrons transferred in COD calculation. Therefore, for COD calculation, one Cl⁻ (one electron transferred) is equivalent to ¼ of an O₂. This can be used to quantify the COD equivalence of Cl⁻ in the sample and deducted the effect of Cl⁻ from the overall COD obtained.

With this mathematical deduction method, the chloride interference can be reduced to less than 5%. A sophisticated mathematical model can be developed by using an artificial neural network system. The method requires exhaustive oxidation of Cl⁻, which may compromise the assay time because the slow kinetic of chloride oxidation. The method requires using a chloride sensor, which will increase the complexity and the cost of the analytical system.

In another embodiment the present invention provides a method of determining chemical oxygen demand in water samples containing chloride ions above 0.5 mM concentration in which the samples are diluted and a known quantity of an organic substance is added to the diluted sample which is the subjected to an assay by a photoelectrochemical method using a titanium dioxide photoactive nanoparticulate semiconductor electrode and the chemical oxygen demand is measured in the same manner as disclosed in WO2004/088305, except the a known concentration organic solution is used to obtain the blank for calculation of next charge.

With this organic addition method, the analytical signal is generated in exactly the same way as the photoelectrochemical method disclosed in WO2004/088305. Upon absorption of light by the TiO₂ photocatalyst, electrons in the valence band are promoted to the conduction band (e_{cb}⁻) and holes are left in the valence band (h_{vb}⁺). The photohole is a very powerful oxidizing agent (+3.1 V) that will readily lead to the seizure of an electron from a species adsorbed to the solid semi-conductor. Thermodynamically, both organic compounds and water can be oxidized by the photoholes or surface trapped photoholes but usually organic compounds are more favorably oxidized, which leads to the mineralization of a wide range of organic compounds. This is described in application WO2004/088305 the contents of which are incorporated herein by reference.

Owing to the strong oxidation power of photoholes, photocatalytic oxidation of organic compounds at TiO₂ electrode leads to stoichiometric oxidation (degradation) of organic compounds as follows:

C_{y}HₘOⱼNₖX_{q}+(2y−j)H₂O→yCO₂+qX⁻+kNH₃+(4y−2j+m−3k)H⁺+(4y−2j+m−3k−q)e⁻

where N and X represents a nitrogen and a halogen atom respectively. The numbers of carbon, hydrogen, oxygen, nitrogen and halogen atoms in the organic compound are represented by y, m, j, k and q.

In order to minimize the degradation time and maximize the degradation efficiency, the photoelectrochemical catalytic degradation of organic matter is preferably carried out in a thin layer photoelectrochemical cell. This process is analogous to bulk electrolysis in which all of the analytes are electrolysed and Faraday's Law can be used to quantify the concentration by measuring the charge passed if the charge/current produced is originated from photoelectrochemical degradation of organic matter. That is:

Q=∫idt═nFVC

where n refers to the number of electrons transferred during the photoelectrocatalytic degradation, which equals 4y−2j+m−3k−q, i is the photocurrent from the oxidation of organic compounds. F is the Faraday constant, while V and C are the sample volume and the concentration of organic compound respectively.

The measured charge, Q, is a direct measure of the total amount of electrons transferred that result from the complete degradation of all compounds in the sample. Since one oxygen molecule is equivalent to 4 electrons transferred, the measured Q value can be easily converted into an equivalent O₂ concentration (or oxygen demand). The equivalent COD value can therefore be represented as:

$$C O D ( mg \text{/} L of {O}_{2} ) = \frac{Q}{4 FV} \times 32000$$

This COD equation can be used to quantify the COD value of a sample since the charge, Q, can be obtained experimentally and for a given photoelectrochemical cell, the volume, V, is a known constant. It should be mentioned that the charge Q in the equation is the net charge that due purely the oxidation of organic in the sample solution, which is obtained differently when the organic addition method is employed. Under such circumstance, a known quantity of an organic solution, containing the same concentration of supporting electrolyte, is used to replace the supporting electrolyte only solution, for the purpose of obtaining the blank and the net charge is obtained by deducting the total charge from the blank. Any organic compound that can be fully oxidized by the system is suitable for the purpose. The preferred organic compound is glucose or KHP.

Thus the invention also provides a method of determining chemical oxygen demand in water samples containing chloride ions above 0.5 mM concentration in which the samples are diluted with an electrolyte containing a known quantity of an organic substance and the sample is then subjected to an assay by a photoelectrochemical method using a semiconductor electrode and the photo current produced in the sample and said electrolyte is measured wherein the COD value for the sample and the electrolyte solution is determined using the equation

$$C O D ( mg \text{/} L of {O}_{2} ) = \frac{Q}{4 FV} \times 32000$$

where Q is the measure of the electrons transferred as a result of degradation of organic compounds in the sample, F is the Faraday constant and V is the volume of the electrophotochemical cell and the difference in the two values is the COD of the sample.

In another aspect the present invention provides a photoelectrochemical assay apparatus for determining oxygen demand of a water sample which consists of
a) a flow through measuring cell
b) an electrolyte storage holding a solution containing an electrolyte and an organic compound of known concentration
c) a sample injection device for mixing a known quantity of water to be analysed with a known quantity of the stored electrolyte solution and passing the diluted sample through said flow through cell
d) a photoactive working electrode and a counter electrode disposed in said cell,
e) a UV light source, adapted to illuminate the photoactive working electrode
f) control means to control the illumination of the working electrode, the applied potential and signal measurement
g) current measuring means to measure the photocurrent at the working and counter electrodes
h) analysis means to derive a measure of oxygen demand from the measurements made by the photocurrent measuring means.

Preferably a reference electrode is also located in the measuring cell and the working electrode is a nanoparticulate semiconductor electrode preferably titanium dioxide. The flow rate is adjusted to optimise the sensitivity of the measurements. This cell design is based on that disclosed in application WO2004/088305 with means to store the organic/electrolyte solution. The sample collection device preferably includes a filter to remove any large particulates or precipitated substances that may interfere with the operation of the cell.

### DETAILED DESCRIPTION OF THE INVENTION

A preferred embodiment of the invention will be described with reference to the drawings in which:

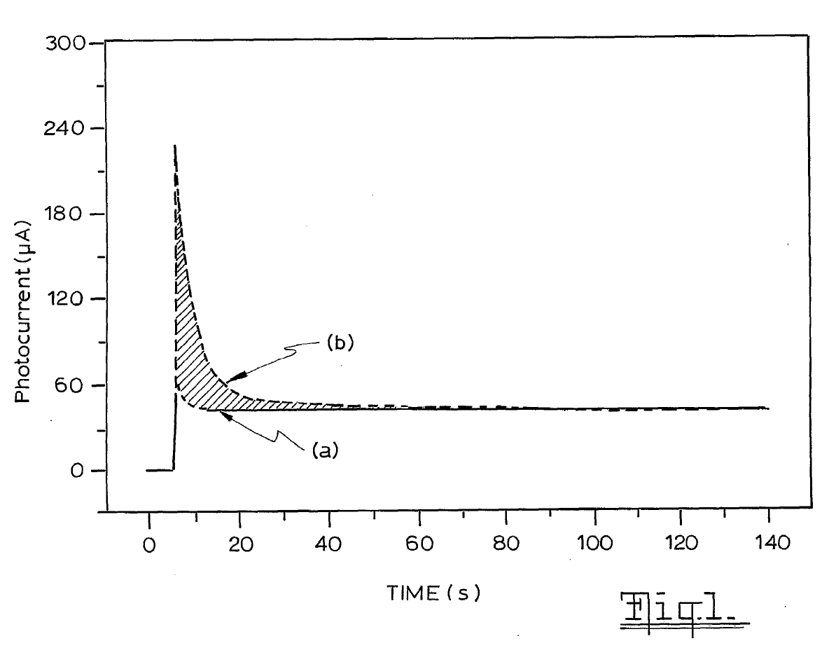

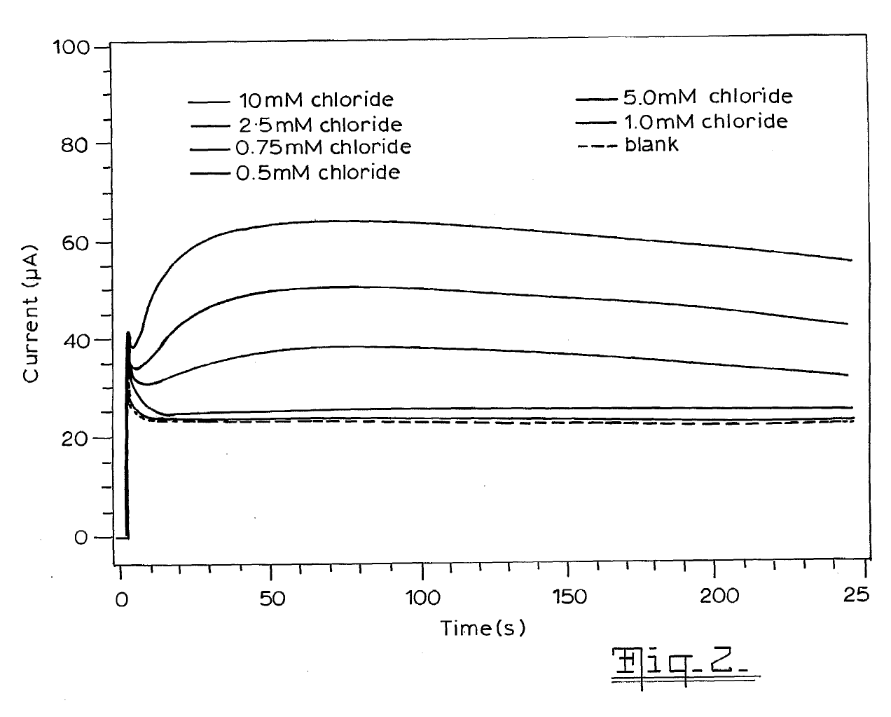

FIG. 1 shows a set of typical photocurrent-time profiles obtained during an exhaustive degradation of organics in the thin-layer photoelectrochemical cell;

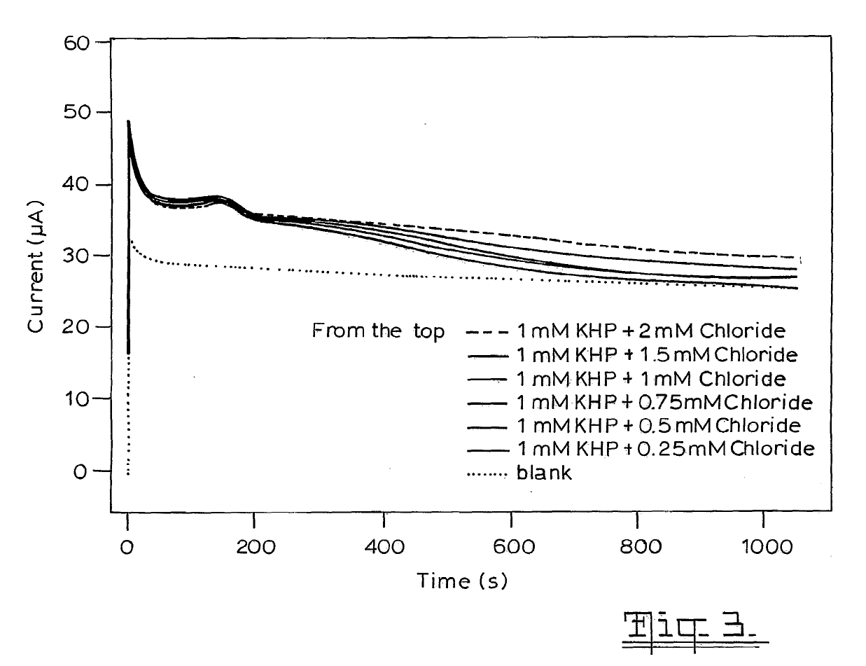

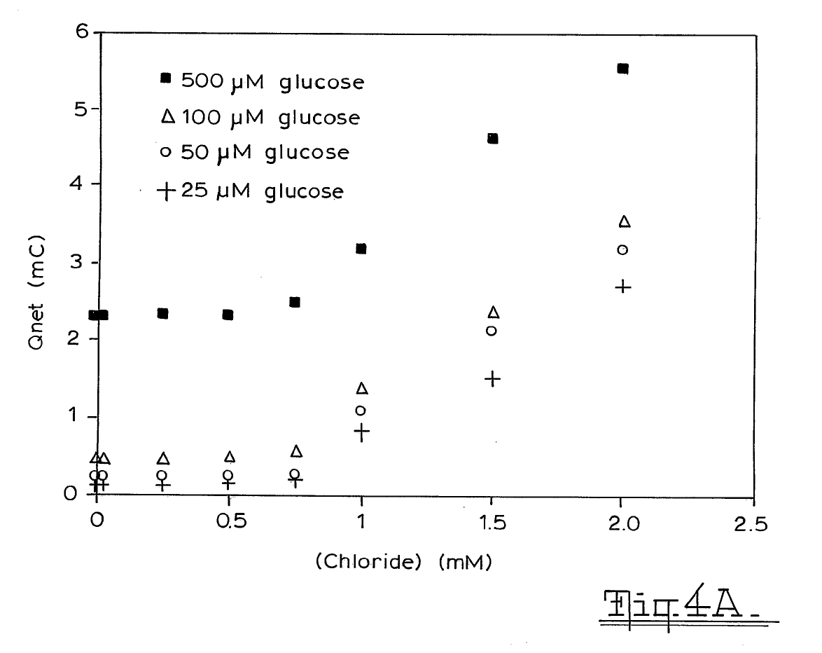

FIG. 2 shows the photocatalytic oxidation of chloride at TiO₂ electrode in the absence of organics;

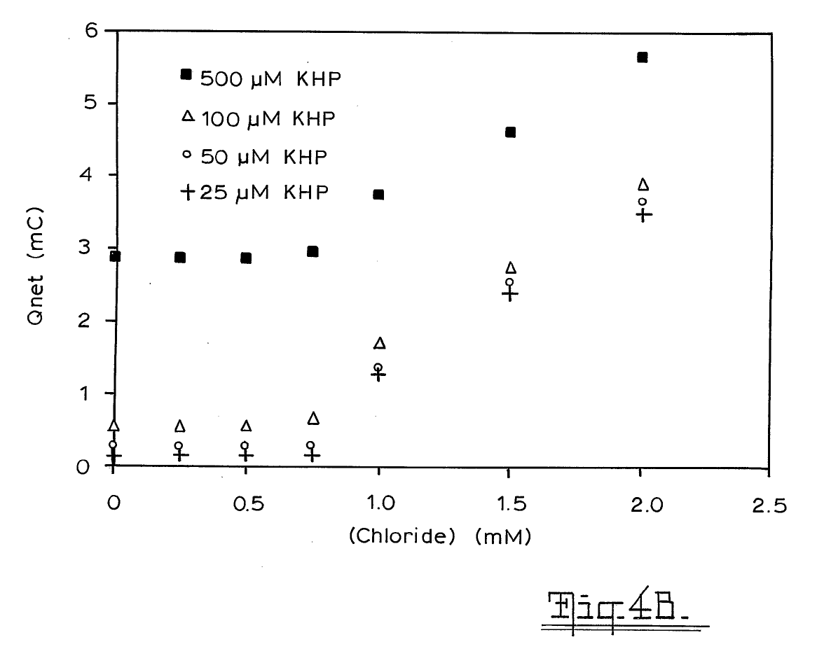

FIG. 3 shows the Photocatalytic oxidation of chloride in presence of 1 mM KHP (240 ppm COD);

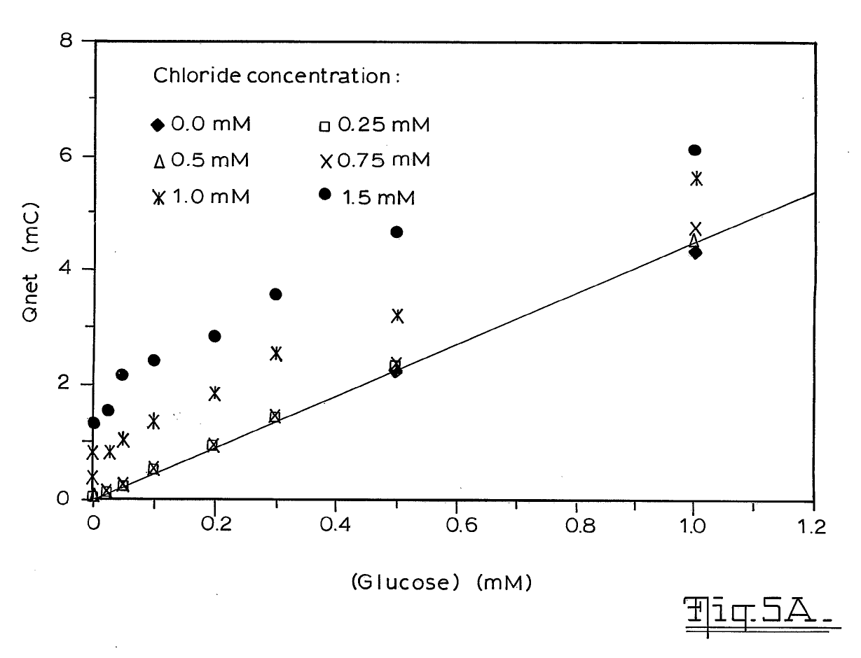

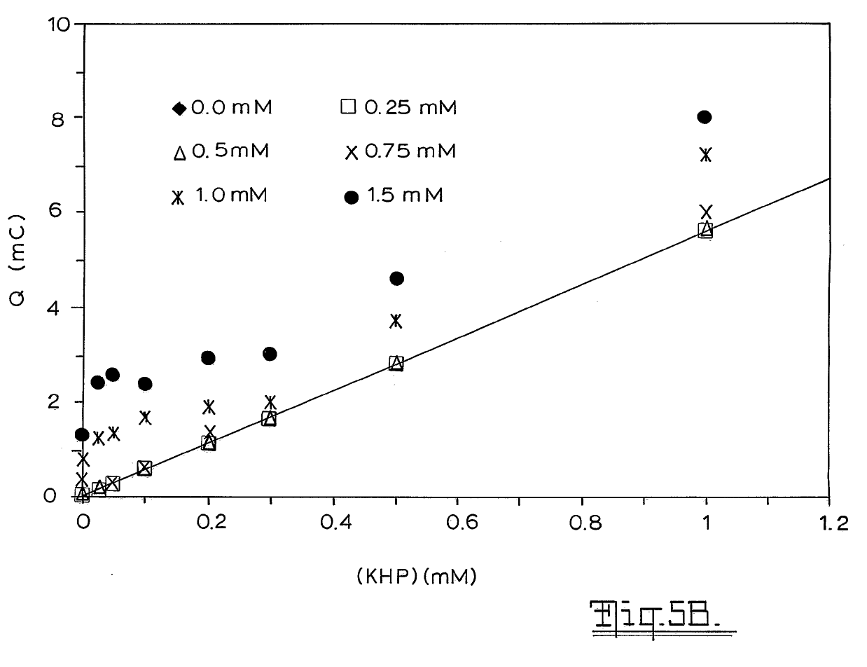

FIG. 4 shows the photocatalytic oxidation of chloride in presence of fixed concentration of organics (a) glucose and (b) KHP;

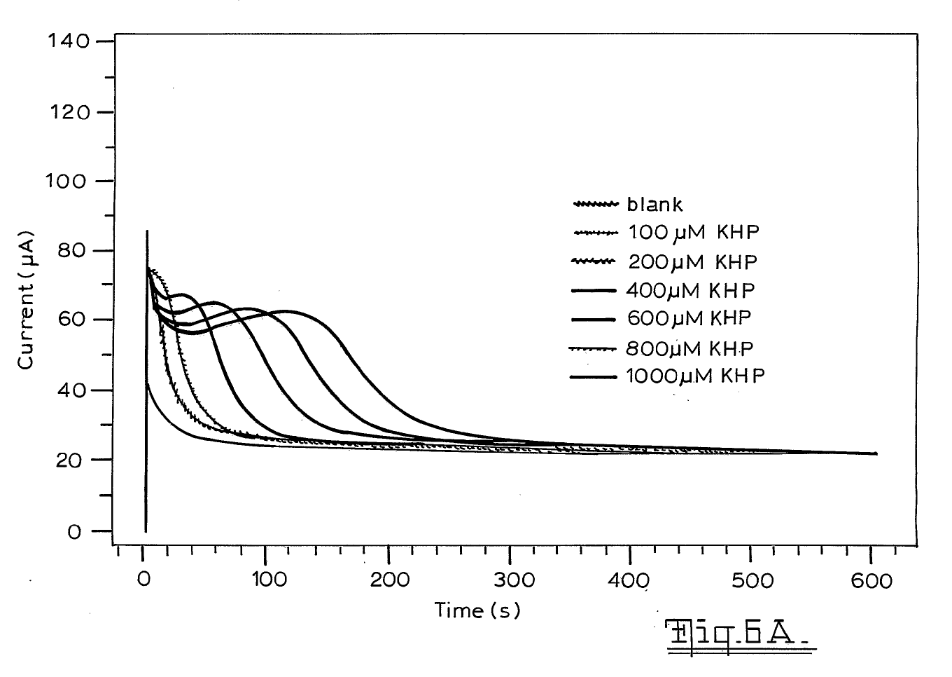

FIG. 5 shows the calibration curves for (a) glucose and (b) KHP with constant concentration of chloride;

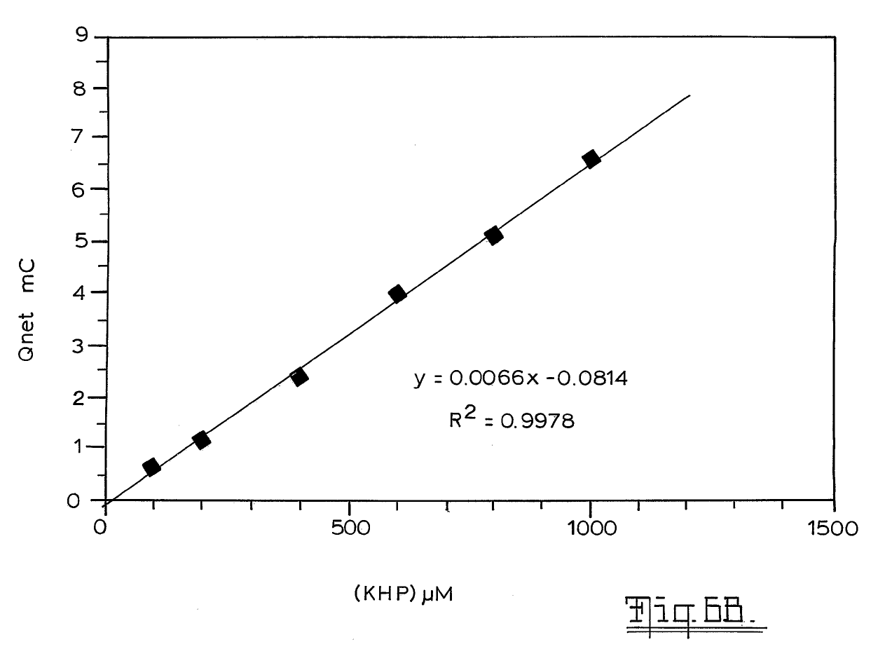

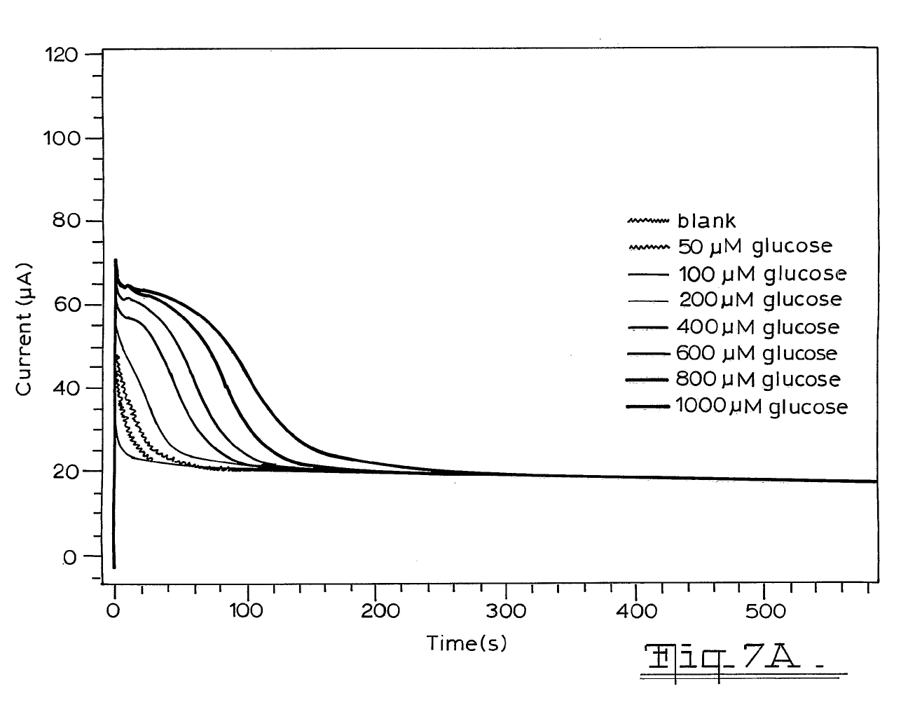

FIG. 6 shows the original signal (a) and calibration curves (b) for KHP;

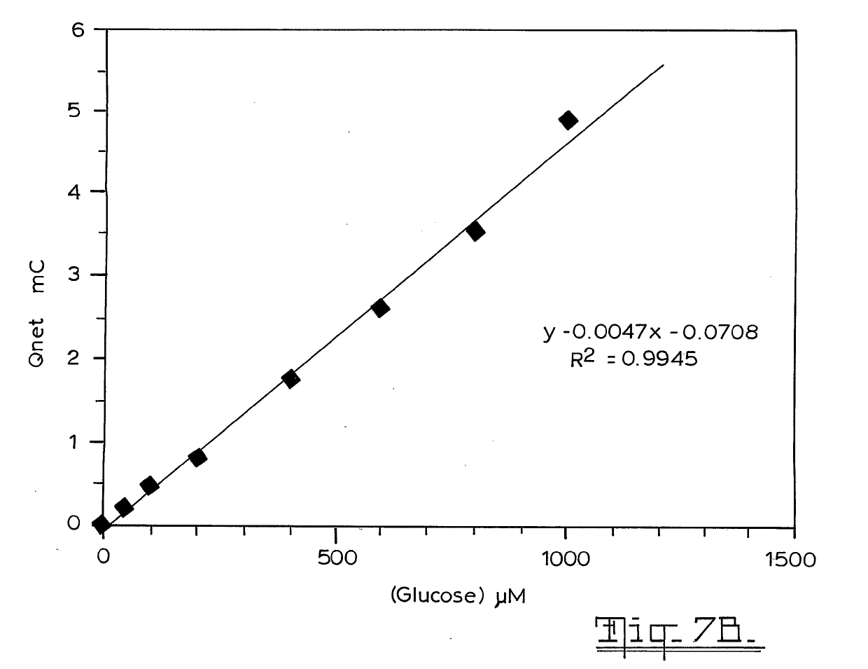

FIG. 7 shows the original signal (a) and calibration curves (b) for KHP

As shown in FIG. 1, under a constant applied potential of +0.30 V, when the light was switched off, the residual current (dark current) was approximately zero. Upon illumination, the current increased rapidly before decaying to a steady value for both the blank and the Blank/sample mixed solutions. For the blank (curve a), the photocurrent resulted from the oxidation of water and added organics, while photocurrent observed from the Blank/sample mixed solutions (curve b) consisted of two current components, one from photoelectrocatalytic oxidation of organics in the sample and the other from the oxidation of water and added organics in the blank, which was the same as the blank photocurrent. When all organics in the sample has been consumed, the photocurrent of the sample solution dropped to the same level as the blank. For a given time period, the charge passed for both blank and the blank/sample mixed solutions can be obtained by integration of photocurrents with time. The net charge originated from the oxidation of organics can be obtained by subtracting the charge of the blank from the charge of the blank/sample mixed solution, which is indicated as the shaded area in FIG. 1. This net charge can then be used to quantify the COD value of a sample according to COD equation.

Comparing the organic addition method with the original method disclosed in WO2004/088305, from methodology point of view, the difference is that a blank solution containing organics is used to replace the normal blank solution, which contains electrolyte (NaNO₃) only. Because the method is based on an absolute measurement, therefore, the net charge obtained by deducting the pure water oxidation current (as original method does) or mixed blank solution oxidation current (as organic addition method does) from the overall current is the same and it makes no different from operational point of view.

The oxidation of chloride is thermodynamically favoured at the illuminated TiO₂ electrode (see FIG. 2).

Chloride is commonly oxidized to chlorine (Cl₂) in photoelectrocatalytic reactions (2Cl⁻+2h⁺→Cl₂).

The produced chlorine can be readily converted into hypochlorite under the UV illumination

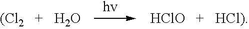

Other possible products include: ClO₂⁻, ClO₃⁻ and ClO₄⁻.

All of oxidising forms (Cl₂, ClO⁻, ClO₂⁻, ClO₃⁻ and ClO₄⁻) are strong oxidants that are thermodynamical able to react with water (in absence of organics).

The photooxidation kinetics of Cl⁻ is slow. When the Cl⁻ concentration is less than 0.50 mM, the water oxidation is the dominant process and the interference of Cl⁻ in the determination of COD is minimal. When the Cl⁻ concentration is greater than 0.75 mM, the interference of Cl⁻ in determination of COD is significant and has to be corrected. This is due to the high concentration of oxidising products and intermedia oxidising species are formed at high concentration of Cl⁻. The subsequent chemical reactions generated by these oxidising products and intermedia species produce Cl⁻, which is re-oxidised at the electrode surface. This results in a catalytic cycle at the electrode surface, recycling the Cl⁻. It is this catalytic cycle that makes the blank photocurrent deviating from the water oxidation blank photocurrent, which causes problems for COD detection.

The photooxidation behaviour of Cl⁻ in absence of organics is very different to that of presence of organics (see FIG. 3).

FIG. 3 indicates the oxidation of organics dominates the initial process even when the Cl⁻ concentration is high. The catalytic cycle that recycles the Cl⁻ at the electrode surface is not formed in the presence of organics. Cl⁻ oxidation becomes significant only after organics are consumed. This provides a theoretical base for organic addition.

The photooxidation behaviour of strong and weaker adsorbents is different. Two typical compounds, glucose (weaker adsorbent) and KHP (strong adsorbent), are selected for determining the critical conditions of organic addition.

Photocatalytic oxidation of Cl⁻ under fixed concentrations of different organics was firstly investigated to identify the critical concentration of Cl⁻ (see FIG. 4)

The critical Cl⁻ concentration for both test compounds is 0.75 mM (26 ppm).

The critical ratio between the organics and Cl⁻ is 1 to 5 (in ppm). These critical conditions have been further confirmed by data obtained from photocatalytic oxidation of Cl⁻ under fixed concentrations (see FIG. 5).

The slopes of the calibration curves are remained the same when the concentration of Cl⁻ is below 0.75 mM and the ratio is greater than ⅕. This implies that under such critical conditions the interference of Cl⁻ for determination of COD is less than 5%. To ensure the interference by Cl⁻ is less than 5%, the absolute Cl⁻ concentration in the sample must be less than 0.75 mM (26 ppm) and the ratio between organic and Cl⁻ should be greater than 1 to 5. The quality and reproducibility of the analytical signal is increased when the organic to Cl⁻ ratio is increased. This means that the accuracy of measurement can be improved by presence of higher concentration of organics, which is one of advantages of organic addition method.

The chloride interference need not be considered when the sample contains less than 0.5 mM (17.5 ppm) of Cl⁻, regardless of the concentration of organic present in the sample. The errors caused by the chloride interference would be less than 5% when organic concentration in the sample is greater than 4 ppm COD and Cl⁻ concentration is less than 26 ppm. The method is applicable for the vast majority of possible samples when the organic addition is combined with appropriate sample dilution.

Typical example 1: A sample containing more than 40 ppm COD equivalent organics, COD can be measured with less than 5% error by a ten fold sample dilution if the Cl⁻ concentration is less than 260 ppm.

Typical example 2: A sample containing more than 1000 ppm COD equivalent organics, then COD can be measured with less than 5% error by a 100 fold sample dilution if the Cl⁻ concentration is less than 2600 ppm.

Technically, the method should not have an upper limit for analytical linear range. However, when the concentration is great than 400 ppm, the oxidation of organic compound produced large amount of CO₂. When the amount of produced CO₂ exceeds the solubility limit, the formation of gas bubbles will affect the system performance.

The upper limit of the analytical range can be extended by employing different cell configuration.

Assay time is dependent of the concentration of organics in the sample. With system configuration as described less than 2 minutes is required to completely oxidise 100 ppm COD equivalent organics. 4.5 minutes is needed for 200 ppm and 8 minutes is needed for 350 ppm. The oxidation efficiency (the extent/degree of oxidation) is fund to be between 94% and 106% depending on the chemical nature of the organics.

The linearity of analytical signal is excellent (see FIGS. 6 and 7).

The results of analysis of field samples using the method of this invention is shown in table 1. All samples were subjected to filtration through a 0.45 μm membrane prior to the analysis.

TABLE 1

| | Cl⁻ | Standard | Organic addition |
|---|---|---|---|
| | Content | Method | Method |
| Samples | (ppm) | COD (ppm) | COD (ppm) |
| Dam water | 4.0 | — | 1.7 ± 0.2 |
| Wastewater treatment | 170 | 59.0 ± 4.7 | 60.5 ± 1.6 |
| plants | | | |
| (Secondary effluent)¹ | | | |
| Wastewater treatment | 108 | 12400 ± 535 | 12130 ± 212 |
| plants | | | |
| (Primary effluent)² | | | |
| Sugar plants | 106 | 49 ± 3.6 | 48.3 ± 0.7 |
| (Treated effluent)³ | | | |
| Sugar plants | 87 | 5718 ± 367 | 5569 ± 96 |
| (Untreated effluent)⁴ | | | |
| Brewery manufacturer⁵ | 185 | 661 ± 37 | 687 ± 13 |
| Dairy manufacturer | 330 | 95 ± 8 | 107 ± 5.2 |
| (Treated effluent)⁶ | | | |
| Dairy manufacturer | 407 | 17500 ± 835 | 16800 ± 397 |
| (Treated effluent)⁷ | | | |

¹analysis was performed with 10 times dilution of original sample and with addition of 19.2 ppm COD equivalent organic standard.
²analysis was performed with 200 times dilution of original sample and with addition of 19.2 ppm COD equivalent organic standard.
³analysis was performed with 10 times dilution of original sample and with addition of 19.2 ppm COD equivalent organic standard.
^{4 5} and ⁶each analysis was performed with 100 times dilution of original sample and with addition of 19.2 ppm COD equivalent organic standard.
⁷analysis was performed with 500 times dilution of original sample and with addition of 19.2 ppm COD equivalent organic standard.

Those skilled in the art will realise that the present invention provides a robust analytical tool that can provide accurate measurement of COD in a short time without interference from competing species such as chloride.

Those skilled in the art will also realise that this invention may be implemented in embodiments other than those described without departing from the core teachings of the invention.

1. A method of determining chemical oxygen demand in water samples containing chloride ions above 0.5 mM concentration in which the samples are diluted and a known quantity of an organic substance is added to the diluted sample which is then subjected to an assay by a photoelectrochemical method using a semiconductor electrode and measuring the photo current produced until a stable value is reached and then using the difference between the initial and stable photocurrents as a measure of the chemical oxygen demand.

2. A method of determining chemical oxygen demand in water samples containing chloride ions above 0.5 mM concentration in which the samples are diluted with an electrolyte containing a known quantity of an organic substance and the sample is then subjected to an assay by a photoelectrochemical method using a semiconductor electrode and the photo current produced in the sample and said electrolyte is measured wherein the COD value for the sample and the electrolyte solution is determined using the equation
$$C O D ( mg \text{/} L of {O}_{2} ) = \frac{Q}{4 FV} \times 32000$$
where Q is the measure of the electrons transferred as a result of degradation of organic compounds in the sample, F is the Faraday constant and V is the volume of the electrophotochemical cell and the difference in the two values is the COD of the sample.

3. An electrolyte solution for use in the method defined in claim 1 consisting of an aqueous solution of a known concentration of an ionic compound and a water soluble organic compound.

4. An electrolyte solution as claimed in claim 3 wherein the organic compound is glucose.

5. Water quality assay apparatus for determining oxygen demand of a water sample which consists of
a) a flow through measuring cell
b) an electrolyte storage holding a solution containing an electrolyte and an organic compound of known concentration
c) a sample injection device for mixing a known quantity of water to be analysed with a known quantity of the stored electrolyte solution and passing the diluted sample through said flow through cell
d) a photoactive working electrode and a counter electrode disposed in said cell,
e) a UV light source, adapted to illuminate the photoactive working electrode
f) control means to control the illumination of the working electrode, the applied potential and signal measurement
g) current measuring means to measure the photocurrent at the working and counter electrodes
h) data processing means to derive a measure of oxygen demand from the measurements made by the photocurrent measuring means.

6. An apparatus as claimed in claim 5 in which the electrolyte storage contains an electrolyte solution consisting of an aqueous solution of a known concentration of an ionic compound and a water soluble organic compound.

7. An apparatus a claimed in claim 6 in which the organic compound is glucose.

8. A method of determining chemical oxygen demand in water samples containing chloride ions which includes the step of measuring the chlorine content and measuring chemical oxygen demand by a photoelectrochemical method and adjusting the chemical oxygen demand measurement using the chlorine measurement.
